(19) United States
(12) Patent Application Publication
(10) Pub. No.: US 2010/0223035 A1
(43) Pub. Date: Sep. 2, 2010

(54) Test Time Calculator

(75) Inventor: Andree Weyh, Bangertweg 34 (DE)

Correspondence Address: Gregory W. Osterloth;Holland & Hart, LLP, P.O. Box 8749, Denver, CO, 80201, US

(73) Assignee: VERIGY(SINGAPORE) PTE LTD, SINGAPORE (SG)

(21) Appl. No.: 12/223,727

(22) PCT Filed: Feb. 6, 2006
(86) PCT No.: PCT/EP2006/050699

§ 371 Date: Apr. 24, 2009

(51) Int. Cl. G06F 17/50

(52) U.S. Cl. 703/2; 703/13

(57) ABSTRACT

An apparatus for estimating a duration of a test of a device under test to be performed by a test device, the apparatus including an input unit adapted for receiving test information indicative of the test to be performed, and a processing unit adapted to estimate the duration of the test of the device under test performed by the test device based on the received test information and based on a model characterizing the test.

### BACKGROUND OF THE INVENTION

The present invention relates to tests of devices under test using a test device.

For testing electronic devices, in particular integrated electronic circuits providing digital electrical output signals, a test or stimulus signal is fed to an input of the device under test, and a response signal of the device under test is evaluated by an automatic test equipment, for example by comparison with expected data. Such an automatic test equipment has included a particular test functionality, that it to say test functions or routines which the test equipment may carry out. This test functionality may be incorporated in the test equipment in the form of executable software code.

When a new product is developed, the functionality of the new product as a device under test (DUT) is evaluated, for instance by carrying out a test in accordance with a particular test scheme. The test time needed for such a test is a significant cost factor for a developer or manufacturer of the product, particularly in the field of storage device products.

### SUMMARY

According to an embodiment, an apparatus for estimating a duration of a test of a device under test to be performed by a test device may have: an input unit adapted for receiving test information indicative of the test to be performed and for receiving a model of the test to be performed; and a processing unit adapted to estimate the duration of the test of the device under test performed by the test device based on the received test information and based on the model of the test to be performed.

According to another embodiment, a test device may have: a test unit for physically performing a test of a device under test; an apparatus for estimating a duration of a test of a device under test to be performed by a test device, wherein the apparatus may have: an input unit adapted for receiving test information indicative of the test to be performed and for receiving a model of the test to be performed; and a processing unit adapted to estimate the duration of the test of the device under test performed by the test device based on the received test information and based on the model of the test to be performed.

According to another embodiment, a method of estimating a duration of a test of a device under test performed by a test device may have the steps of: receiving test information indicative of the test to be performed and a model of the test to be performed; and estimating the duration of the test of the device under test performed by the test device based on the received test information and based on the model of the test to be performed.

An embodiment may have: a computer-readable medium, in which a computer program for estimating a duration of a test of a device under test to be performed by a test device is stored, which computer program, when being executed by a processor, is adapted to control or carry out the method of receiving test information indicative of the test to be performed and a model of the test to be performed; and estimating the duration of the test of the device under test performed by the test device based on the received test information and based on the model of the test to be performed.

An embodiment may have: a program element for estimating a duration of a test of a device under test to be performed by a test device, which program element, when being executed by a processor, is adapted to control or carry out the method of receiving test information indicative of the test to be performed and a model of the test to be performed; and estimating the duration of the test of the device under test performed by the test device based on the received test information and based on the model of the test to be performed.

According to an exemplary embodiment of the present invention, an apparatus for estimating a duration of a test of a device under test to be performed by a test device is provided, the apparatus comprising an input unit adapted for receiving test information indicative of the test to be performed (for example parameters or frame conditions specifying a planned test), and a processing unit adapted to estimate the duration of the test of the device under test performed by the test device based on the received test information and based on a model characterizing the test (for example for realistically mapping a physical test into a theoretical, numerically evaluatable virtual model).

According to another exemplary embodiment of the present invention, a test device is provided, comprising a test unit for physically performing a test of a device under test, and an apparatus having the above mentioned features for (theoretically) estimating an expected duration of a (virtual) test of the device under test to be performed by the test unit.

According to another exemplary embodiment, a method of estimating a duration of a test of a device under test performed by a test device is provided, the method comprising receiving test information indicative of the test to be performed, and estimating the duration of the test of the device under test performed by the test device based on the received test information and based on a model characterizing the test.

According to still another exemplary embodiment, a computer-readable medium is provided, in which a computer program of estimating a duration of a test of a device under test to be performed by a test device is stored, which computer program, when being executed by a processor, is adapted to control or carry out the above-mentioned method.

According to yet another exemplary embodiment, a program element of estimating a duration of a test of a device under test to be performed by a test device is provided, which program element, when being executed by a processor, is adapted to control or carry out the above-mentioned method.

Embodiments of the invention can be partly or entirely embodied or supported by one or more suitable software programs, which can be stored on or otherwise provided by any kind of data carrier, and which might be executed in or by any suitable data processing unit. Software programs or routines can be advantageously applied for estimating a duration of a test of a device under test to be performed by a test device. The test time determination according to an embodiment of the invention can be performed by a computer program, i.e. by software, or by using one or more special electronic optimization circuits, i.e. in hardware, or in hybrid form, i.e. using software components and hardware components.

According to an exemplary embodiment, a system may be provided which allows, in advance, to evaluate or determine a theoretical value of a test duration of a planned test for testing one or more devices under test (for instance a developed or manufactured storage device like a DRAM). As a basis for such a calculation, a user may specify details with regard to the test to be performed by providing information concerning the kind or number of devices under test (for instance perform a test of 64 DRAM devices), the test machine intended to be used for such a test (for instance the information that a test apparatus of the 93000 series of Agilent Technologies shall be used for the test), or a specific test pattern. On the basis of such information in combination with a (for instance prestored or predetermined) model characterizing the test, that is a model of a test procedure to be performed, a virtual/expected test time may be estimated.

Thus, a processor of such a system may then calculate a test time making reasonable assumptions and making use of formula which may be derived for a particular test sequence in correspondence with characteristics of the DUT. Such a theoretical model in combination with information specifying a physical device under test may be used to simulate such a test in order to derive information about a time of a real future test during which a physical device under test will be actually tested on a physical test device.

Such a test time may be output, if desired in combination with a corresponding test cost which is based on the estimated test time. Thus, a manufacturer or developer of a device under test may know in advance which amount of money will be spent when a device under test is tested on a test device.

Such a test apparatus may be designed as an electronic device or may be also designed as a pure mechanical solution, similar like a petrol consumption sheet in which different input parameters may be adjusted (for instance by turning paper wheels into positions corresponding to the respective parameters) so as to allow a user to read out an output parameter indicating a test time. It is also possible that the apparatus is realized as some kind of table, particularly a multi-dimensional table, in which a combination of input parameters, for a particular test routine, may allow to derive the test time and/or the test costs by looking at a corresponding value in such a (look-up) table.

Thus, computational resources or a certain logic may be implemented for designing the test apparatus.

According to an exemplary embodiment, a mathematical model for test time prediction of IC test systems (or measurement instruments in general) may be provided to predict test time and/or test cost.

ICs or other electronic products are in many cases developed in a design house (for instance in California), then produced, and tested in a test house (for instance in Taiwan). The billing of the test service of the test house is determined by or may be dependent on the test time (that is the time it takes to test a device using a test device and a test procedure). Therefore, it may be of interest for the design house to understand how much test time they have to pay for in the test house. According to an exemplary embodiment, this cannot only be found out after the test has been done, but it is possible to inform a design house upfront, before the test starts, so that they can plan what they have to pay. They can also use this information to optimize the test of the device (for instance trade off test coverage, reduce test time).

In accordance with the foregoing, a mathematical model for the test time of an IC tester or a measurement instrument in general is provided to predict the measurement time.

In particular, a software tool may be provided which calculates the estimated test time of an IC. This may comprise the following four parts:

1. Measure the test time of a typical/characteristic IC on an IC tester under varying conditions. Exemplary conditions are the type of the IC tester and versions of the measurement instruments, the speed of the tester controller/workstation, the operating system of the controller/workstation, the amount of test data (that is to say what shall be tested), or the speed of the test/the test frequency.
2. A mathematical model may be derived to symbolize the test time.
3. The estimated test time may be calculated for a specific test program based on the test program to test a specific IC including number of test and test characteristics.
4. Estimated test costs may be calculated based on calculated test time (optionally).

It may also be possible to include an expert system to suggest test time improvements in the test program of an IC. Therefore, test programs may be, automatically or under control of a user, changed to improve test time of the IC in accordance with the result of such an expert system. Therefore, a user may concretize test parameters (including multi-port/multi-size test parameters or the like). Then, such parameters, in combination with a particular test procedure may be converted into a model (which may include calculations on the basis of formula, logical paths or the like). Then, such a model may be used to calculate or compute the test time, and if desired the corresponding test costs.

The test time calculator may be provided as a separate device or service or may be designed as a feature of a correspondingly modified test device, like the 93000 SOC device of Agilent Technologies. With such a test device, the proper function of any device under test (DUT) may be checked so as to obtain the result whether a particular DUT has passed or failed the test. Such a DUT may be, for instance, a system-on-chip in an integrated circuit (IC), a central processing device (CPU), a storage device (for instance a DRAM memory product), or any other product.

For instance in a scenario in which an IC tester is provided, an IC to be tested may be connected, at its pins, to corresponding pins of the IC test device. Then a test may be performed to characterize whether the IC product works properly or not. Such a chip test may be performed during or after production of the chip product, for instance with a multiple throughput method. Thus, in a fast and relatively cheap manner, information may be obtained whether the IC test has passed the test or has failed the test.

In order to improve the way of planning such tests, embodiments of the invention allow to provide a test client with information in order to estimate the test time and therefore the test costs in advance. This may be an important information which may be used during development of the product so as to be in accordance with requirements of the IC market. Therefore, a manufacturer or developer of processors, memories, SOCs (system-on-chip), or hybrid circuits may know in advance which costs will arise for testing the proper technical function of the DUT after manufacture.

DUT-related Parameters which may have an influence on the test time are the kind of DUT being tested (a logic device, a memory device, an analog circuit, a radio frequency circuit, etc.), the clock frequency or test rate being available, and information concerning the memory depth of a DRAM as a DUT. Such parameters may depend on the technology of the DUT and should be provided when defining which DUT shall be tested in the (virtual) test.

Test device related parameters for the test to be carried out as a simulation may concern the question how many test devices and how many DUTs per test device may be tested. This involves the question whether a parallel and/or sequential test can be carried out, and whether a single site test or a multi-site test is performed. The configuration of a test device for testing the DUTs may be taken in account as well. Such considerations relate to the requirements of the test device and such information may be provided by a manufacturer of the test device.

Test routine related parameters for the test to be carried may be relevant as well. Thus, the type of test or tests to be carried out may be considered as well for estimating the test time. This may include information whether a digital logic test (involving only the application and reading of logic values “0” or “1”) is carried out, whether a DC test (that is to say the measurement of constant analog current values), which typically takes longer than a digital test, or a radio frequency test (that is to say test for circuits or parts of circuits that control antennas, e.g. antennas for mobile phones) shall be carried out. Beyond this, this may include the question whether a memory test shall be carried out which may include read and/or write cycles in the test device using, for instance, analog wave forms. Furthermore, a test sequence may be taken into account, for instance a scheme indicating that individual memory cells, rows of memory cells, columns of memory cells, diagonals of memory cells, etc. of a memory cell array are tested by read/write cycles.

Thus, in particular, DUT technology characteristics, test device characteristics or parameters, and test procedure characterizing parameters may serve as input parameters for defining a test on the basis of which an estimation of the test time may be possible.

Such parameters may be input in the system, and may serve for specifying an abstract theoretical model so as to bring the apparatus in a proper position to calculate the test time and/or the test costs.

Therefore, the test system may be modelled by inputting input parameters/characteristic data (which may be estimated or measured), and as an output the test time and test costs may be derived.

For instance, a logic test may be carried out with a device under test. In the context of such a logic test, signals representing logical values “0” or “1”, in particular sequences of such signals, are applied to a plurality of pins of the device under test, as a stimulus signal, wherein the logical values may be altered in accordance with a test frequency or rate. In accordance with the functionality of the DUT logic, response signals are output at output pins of the DUT and may be compared by the test device with expected values so as to decide whether a DUT has passed or failed the test. In such a scenario, the test time may include a contribution of a warm-up time of the test device, an actual test time which may be proportional to or dependent on a number of test signals (that is to say the number of logic values “0” and “1” applied to pins of the device under test) multiplied with the reciprocal of the test frequency, and may include an overhead time at the end of the tests, that is to say a time needed for providing the output of the test at an output interface. Such a test time of a single DUT may be multiplied with the number of DUTs to be tested in a purely sequential test, wherein a switching time between the tests of different DUTs should be added. Saved time due to an at least partially parallel DUT test with the test device may be taken into account as well in order to compute a realistic test time.

An exemplary equation suitable for deriving a test time T_{logic} for a logic test is the following:

T_{logic}=n×T+Tₛₜₐᵣₜ+Tᵣₑₛᵤₗₜ (1)

In this equation, T_{logic} is the estimated test time. n is the number of test patterns applied to a device under test and may be, for instance, in the order of magnitude between 10³ and 10⁶. T is the reciprocal of the test frequency f, and may be denoted as the clock rate. f may be in the order of magnitude between 50 MHz and 3.6 GHz. Tₛₜₐᵣₜ is the warm-up time of the test device and may be, in a realistic scenario, in the order of magnitude between μs and ms. Tᵣₑₛᵤₗₜ may be denoted as a time necessitated to provide the result at an output interface of the test device, and may also be in the order of magnitude between μs and ms.

For a memory test, that is to say for testing a memory like a DRAM representing a matrix-like arrangement of memory cells, the following test time formula may be appropriate:

Tₜₑₛₜ=n×m×T+Tₛₜₐᵣₜ+Tᵣₑₛᵤₗₜ (2)

In equation (2), m denotes the number of the memory cells which may be in the order of magnitude of 500 millions. Again, n may be a number representing a number of read/write cycles or, more generally, of a test pattern applied to each of the memory cells. For instance, a logic value “1” and a logic value “0” may be programmed in and read out from each of the memory cells (individually or groupwise), so that in this scenario n may be four. Again, T represents the reciprocal of the test frequency f and may be denoted as the clock rate. Tₛₜₐᵣₜ may be the warm-up time of the test device, and Tᵣₑₛᵤₗₜ may be the time necessitated at the end of the test to provide the test result at an output interface for further analysis.

For a proper calculation of the test time Tₜₑₛₜ, the device according to an exemplary embodiment of the invention may include a database in which different test patterns or routines are pre-stored, in combination with further information concerning particular DUTs, concerning particular test devices, etc. A user may then specify the actual test to be performed in combination with the actual DUTs to be tested and the actual test device used. The pre-stored information from the database may then be combined with the parameters defined by the user so as to derive a realistic test time.

According to exemplary embodiments of the invention, the test time calculator may be provided as a service software available on a computer-readable medium like a CD or a harddisk, may be provided as a service to be provided against payment of a fee, may be implemented directly on a test device or may be also presented on a web page as a client support service feature which can be used via a network, for instance via the Internet or via an intranet.

Next, further exemplary embodiments of the invention will be explained. In the following, further exemplary embodiments of the apparatus for estimating a duration of a device under test to be performed by a test device will be explained. However, these embodiments also apply for the test device, for the method of estimating a duration of a test of a device under test performed by a test device, for the computer-readable medium and for the program element.

The test information may comprise at least one of the group consisting of information indicative of the device under test, information indicative of the test device, and information indicative of a test routine to be applied to the device under test by the test device during the test. Particularly, these complementary pieces of information are important parameters which may have a significant influence on the test time. Thus, this set of parameters is easy to handle and is providable to the apparatus in a machine readable format with low effort, and may nevertheless serve as a proper basis for calculating a realistic test time.

The input unit may be adapted for receiving the model characterizing the test. In other words, a user may specify the model or scheme which can be used by the apparatus to calculate the test time.

The input unit may be or may comprise a graphical user interface (GUI). Such a graphical user interface may include a display device (like a cathode ray tube, a liquid crystal display, a plasma display device or the like) for displaying information to a human operator, like data related to the DUT, the test device or the test to be carried out. Further, a graphical user interface may comprise an input device allowing the user to input data (like data specifying the DUT or the test) or to provide the system with control commands. Such an input device may include a keypad, a joystick, a trackball, or may even be a microphone of a voice recognition system. The GUI may allow a human user to communicate in a bi-directional manner with the system.

The apparatus may further comprise a database in which the model characterizing the test is prestored. Such a database may include, for instance, a selection of test procedures supported by a particular test device or by a particular group of test devices. Furthermore, the database may include information concerning the individual test devices and may already include models with respect to a selection of DUTs.

Such information may be used by a processor for the calculation of the test time, as well as empiric or experimental data which may also be stored in the database, and which may represent information derived from the experiences of tests performed in the past. Such a database may be a relational database and may include the necessitated information in the form of a look-up table so as to allow a fast search of the content of the database. Information of the database may be stored in a mass storage device, like a hard disk, a flash memory card, a USB stick, etc.

It is also possible that the processor unit according to an exemplary embodiment of the invention may include a neural network or any other kind of artificial intelligence system which may be operated in a self-adaptive manner. In other words, an experience of the apparatus made in the past may be taken into account so that the system becomes better and better over its entire life period. A comparison of calculated and experimentally measured test times may be fed into a neural network to train the neural network which may be incorporated in the processor device.

The model characterizing the test may be a mathematical model. For instance, the model may be described by empiric or theoretically derived formulas representing a formal description of a test scheme which may be formulated according to a logical structure allowing a machine to use such a model as a recipe for calculating the test time. This may allow for a fast and reliable calculation of the test time.

The model characterizing the test may comprise at least one of the group consisting of a formula for calculating the duration of the test based on the received test information, empiric data derived from previously performed tests, and experimental data measured during previously performed tests. These and other items of information may be used to calculate a realistic test time.

It is also possible to calculate a test time a plurality of times in accordance with different models, and to evaluate the individually calculated test time results so as to derive more reliable information about the test time. For instance, these individual test time values calculated according to different models may be mathematically averaged. An arithmetic mean or a median may be calculated from such a set of test times.

The model characterizing the test may take into account at least one of the group consisting of a warm-up time of the test device before starting the test, a test result transmission time of the test device after finishing the test, a test rate with which the test is performable, a number of test interfaces of the device under test, a number of sub-regions of the device under test to be tested (for instance pins to which signals are applied and from which signals may be received), a number of devices under test (for instance 64 or 256 DRAMs tested with one test apparatus), a switch time for switching between different test steps during performing the test (in an at least partially sequential test routine), and a delay time resulting from an at least partially sequential test. These parameters are meaningful sources of information defining circumstances on which the test time may depend.

The device under test may comprise at least one of the group consisting of a memory device, a DRAM memory device, a logic device, an electric circuit, an integrated circuit, a processor, a system-on-chip, and a hybrid circuit. However, this list is only exemplary, and any other electronic device under test, particularly any IC product, including logic circuits and memory arrays, may be DUTs used for estimating the test time.

The term “test” may cover particularly device tests for verifying the quality of a product before the product is commercially sold. However, the term “test” may also cover an experiment performed with a machine, for instance a physical, biological or chemical experiment. For instance, the system may calculate in advance the possible duration of a, for instance scientific, experiment, like a fluid separation experiment performed with a liquid chromatography device (like a HPLC) or with a gel electrophoresis device. Also in the case of such measurement devices it may be desirable to know in advance how long a measurement or test may take, in order to efficiently employ available resources. The system according to an embodiment may also calculate a time needed by a processor (for instance of a powerful supercomputer) to perform a particular calculation. When different entities share such computational resources, the distribution of the computational resources may be improved based on the knowledge of needed time slots.

The processing unit of the apparatus may be adapted to evaluate a cost for performing the test based on the estimated duration of the test and based on a predetermined cost per time data. Since, for many test service providers, the test costs are (directly) proportional to the test time, it may be possible with reasonable computational burden to calculate a realistic test cost value which may help a developer developing a technical device for considering economic circumstances of product development and product quality control.

The apparatus may be adapted for estimating a duration of a test of a plurality of devices under test to be performed by the test device. Thus, the calculation of the test time is not restricted to the testing of a single DUT, but may take into account the testing of a plurality of DUTs, particularly in an at least partially sequential and/or in an at least partially parallel manner.

The apparatus may further comprise an output unit which may be adapted to output the estimated duration of the test. The output may provide the test result as a simple number or value (namely the test time) or may represent individual partial test times of different test steps or test portions. This may give a human user a better impression of weak points in the test routine which may be circumvented or overcome when being detected.

The apparatus may further comprise a proposal unit adapted to propose a modification of the test so as to reduce the duration of the test. For instance, when a particular weakness has been determined in a test routine (for instance a portion of a test algorithm which has turned out to be the bottleneck for a faster test), for instance since one partial test time is significantly larger than an expected value or an average value, the proposal unit may try to check alternative test patterns which may also derive reliable test result, but which may be performable with a (significantly) reduced test time. A man-machine interaction between the proposal unit and the human operator is possible, so that the human operator may rule out special proposals of the proposal unit which may be in disagreement with requirements of the user. By such a man-machine interaction, the skills of the machine (namely a high computational power) and of the human being (namely a competence-based or experience-based “feeling” for test requirements) may be combined. Such a test routine improvement may be obtained by one or more iterations.

Particularly, the proposal unit may be adapted to propose the modification based on expert rules. Expert rules may be general rules which are derived from a long time experience in a particular technical field (like the field of device tests), and may serve for a realistic and reliable proposal.

In the following, further exemplary embodiments of the method of estimating a duration of a test of a device under test performed by a test device will be explained. However, these embodiments also apply for the apparatus, for the test device, for the program element and for the computer-readable medium.

The method may comprise receiving the test information via a communication network, particularly via the Internet. The accessibility of test information via a communication network may make the access to the test results very fast, so that a test time can be derived with low effort. Such a network can be any telecommunication network, any wired or wireless network, for instance a LAN, a WLAN, an intranet, the Internet, or the like.

The method may comprise providing the estimated duration of the test via a communication network, particularly via the Internet. In other words, not only the reception of the test information, but also the provision of the estimated duration of the test may be provided via a network which allows for a fast bi-directional communication using existing network systems.

### BRIEF DESCRIPTION OF DRAWINGS

Embodiments of the present invention will be detailed subsequently referring to the appended drawings, in which features that are substantially or functionally equal or similar will be referred to by the same reference signs and in which:

FIG. 1 shows an apparatus for estimating a duration of a test of a device under test to be performed by a test device according to another exemplary embodiment of the present invention;

FIG. 2 shows a test device according to another exemplary embodiment of the present invention;

FIG. 3 shows a scheme for estimating a duration of a test of a device under test to be performed by a test device according to another exemplary embodiment of the present invention;

FIG. 4 shows a scheme of an apparatus for estimating a duration of a test of a device under test to be performed by a test device according to another exemplary embodiment of the present invention; and

FIG. 5 shows a scheme for estimating a duration of a test of a device under test to be performed by a test device according to another exemplary embodiment of the present invention.

The illustration in the drawing is schematically.

### DETAILED DESCRIPTION OF THE INVENTION

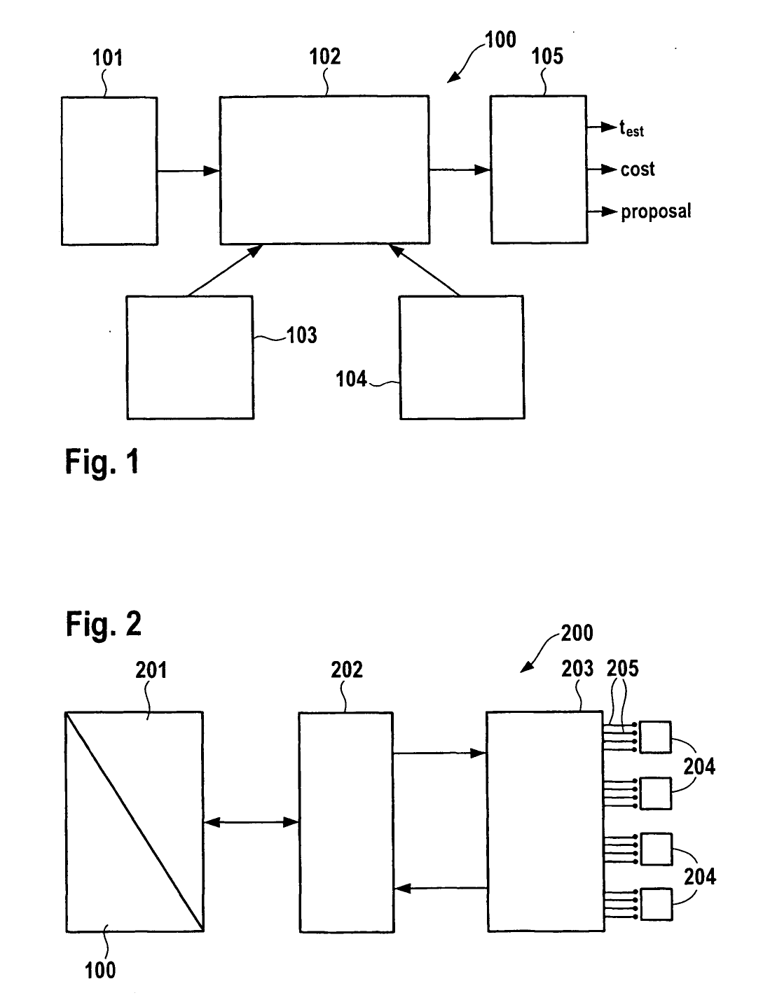

In the following, referring to FIG. 1, an apparatus 100 for estimating a duration of a test of a device under test to be performed by a test device will be explained in detail.

The apparatus 100 comprises an input unit 101 which is adapted for receiving test information indicative of the test to be performed. Such test information specifying the test to be performed may be provided from the input unit 101 to a microprocessor 102 (for instance a central processing unit, CPU). This processing unit 102 is adapted to estimate the duration of the test of the device under test performed by the test device based on the received test information and based on a model characterizing the test.

The test information provided by the user via the input unit 101, which may be graphical user interface, may specify the device under test to be tested (for instance a particular DRAM storage IC product), information characterizing the test device (for instance an Agilent 93000), and information indicating a test routine which a user wished to apply to the device under test. The model, for instance a logic scheme simulating procedures according to a test routine which characterizes the test, may be defined by a user via the input unit. However, a database unit 103 is provided in which a selection of different models characterizing different tests are prestored.

Therefore, in order to specify a particular test, the user may input via the input unit 101 simply a generic name of a test, and the processor 102 may request the information concerning the test model from the database 103, based on this generic name. For instance, the user may specify that the test “XYZ” shall be carried out on a test device “ABC” for testing DUTs “123”. Therefore, it may be very easy to operate the system 100 by a user, since generic definitions of names, for instance in a menu-controlled manner, may be input.

Furthermore, information specifying a test, a test device or a DUT may also be provided by a test service provider via a test service provider unit 104. Therefore, confidential information of the test service provider may be provided “invisible” for a user, wherein the data provided by the test service provider unit 104 may be derivable from the system 100 only with a corresponding authorization.

The processor unit 102 may then use the information provided by the entities 101 and/or 103 and/or 104 so as to calculate a test time. For this purpose, formulas for calculating a duration of the test based on the received test information, empiric data derived from previously performed tests, and/or experimental data measured during previously performed tests may be used. The processor unit 102 may take into account, for estimating a test time, a warm-up time of the test device before starting the test, a test result transmission time of the test device after finishing a test, a clock rate with which the test is performable, a number of test interfaces of the device under test, a number of sub-regions of the device under test to be tested, a number of devices under test to be tested, a switch time for switching between different test steps during performing the test, and a delay time resulting from an at least partially sequential test.

The results of the calculations of the processing unit 102 may be provided at an output unit 105, which may also be a graphical user interface. Output parameters provided by the output unit 105 are the estimated test time tₑₛₜ, a test cost cost, and, optionally, an output proposal including hints or suggestions how to improve the test in order to reduce the test time.

In the following, referring to FIG. 2, a test device 200, for instance a correspondingly modified Agilent 93000 test device, according to an exemplary embodiment of the invention will be described.

The test device 200 comprises a test unit 201 for physically performing a test of devices under test 204, for instance DRAM memory products, which are connected to pins 205 of a reception unit 203. Via the test unit 201, a test to be carried out may be specified by a user. The test unit 201 may be, for instance, a computer via which the test may be carried out. The user specifies a test to be carried out so that a control unit 202 may then control the test in accordance with the defined test. This may include the application of test signals provided from the control unit 202 to the reception unit 203 and from there to the various pins 205 connected to the DUTs 204.

After having received one or more of such stimulus signals, the DUTs 204 generate, in correspondence with their functionality, response signals at other pins 205 which may be received by the reception unit 203 and conveyed to the control unit 202. These test results may be evaluated by the control unit 202 and/or by the test unit 201. A result of this analysis is the test result which may be provided to a user, for instance in a visual manner or as a file from which the user may gather the information which of the DUTs 204 have passed the test and which of the DUTs 204 have failed the test.

Furthermore, a test time calculation feature is provided directly on the test device 200, indicated by the reference numeral 100. Before, during or after having carried out the real test, a user may therefore, independently or in combination with the particular test to be carried out, virtually estimate the test time so as to have a feeling which test time is realistic.

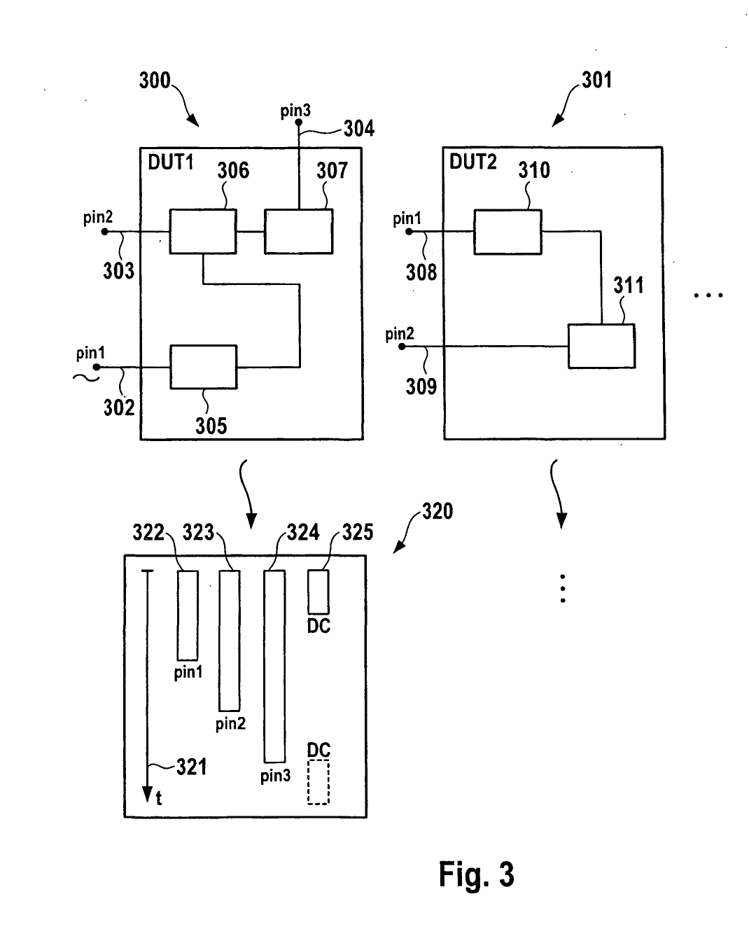

In the following, referring to FIG. 3, a scheme as to how to calculate a test time for a particular test will be explained.

The scheme of FIG. 3 shows a first DUT 300 and a second

DUT 301 to be tested.

As can be taken from FIG. 3, the first DUT 300 has a first pin connection 302, has a second pin connection 303 and has a third pin connection 304. The first pin connection 302 is connected to an analog-to-digital converter unit 305 forming a part of the functionality of the DUT 300. The analog-to-digital converter 305 is coupled to a logic unit 306 which is also accessible via the second pin 303. A memory unit 307 is connected to the logical unit 306 and is controllable via the third pin 304.

Furthermore, the second DUT 301 shall undergo a test. The second DUT 301 has a first pin 308 and a second pin 309. The first pin 308 is connected to a logic unit 310, and the logic unit 310 is connected to a memory unit 311 which is also connected to the second pin 309.

The components 305 to 307, 310, 311 and their coupling provide the functionality of the DUT 301, 302. Before the DUTs 300, 301 are sold as products, they have to pass a test, the test time of which test shall be evaluated.

It is indicated in FIG. 3 that a plurality of further DUTs may undergo a test.

FIG. 3 further shows a diagram 320 which may be taken as a basis to understand as to how an apparatus 100 calculates the test time for testing the DUTs 301, 302, . . . .

The block diagram 320 is related to the first DUT 300. A test time 321 is plotted along an axis. Furthermore, test bars 322, 323 and 324 are plotted showing the individual test times necessitated for applying signals and receiving response signals at the pins 302 to 304. Since the test is carried out parallel, all of the test steps 322 to 324 are performed simultaneously in time so that the longest test time, in the case of FIG. 3 the test time related to the test time bar 324, determines the entire test time.

Furthermore, in this multi-port test, a DC test (direct current test) 325 is carried out, also completely parallel, so that the completely parallel performance of the test has the consequence that only the bar 324 determines the entire test time. However, as it is also indicated with a dotted box in FIG. 3, in case that a DC test 325 is performed sequentially, then the DC test would start only after finishing the test with pin 3 is finished, so that in this case this partially sequential test would prolong the entire test time by the individual test time of the DC test 325.

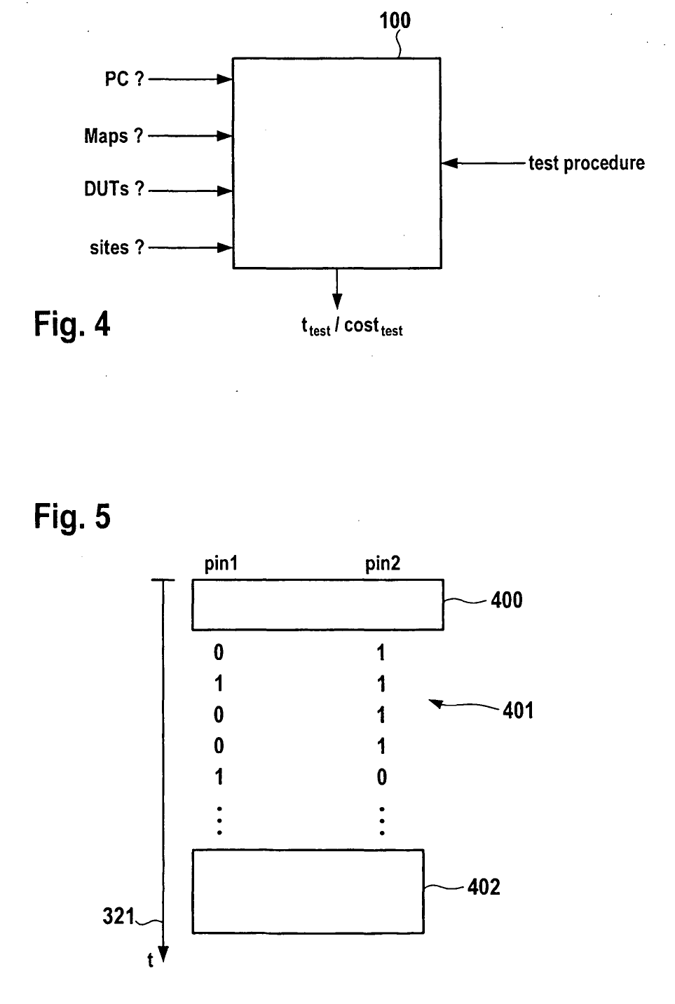

FIG. 4 shows a scheme which illustrates which items of information may be input to the apparatus 100 so as to derive the necessitated test information. This necessitates the information which test device or PC is used, which mapping rules are applied, which and how many DUTs are tested, and how many sides are involved in the test. Furthermore, parameters indicating a test procedure are input parameters of the apparatus 100. As output parameters, the test time tₜₑₛₜ and/or the test costs costₜₑₛₜ are output.

In the following, referring to FIG. 5, a further scheme is illustrated showing a logic test applied to a first pin 1 and to a second pin 2 of a DUT. The test time 321 is plotted along a corresponding axis. At the beginning of a test, a warm-up time 400 has to be considered, followed by the performance of the actual test sequence, that is to say by the application of logical values “0” and “1” to the different pins. At the end, a further overhead 402 has to be considered which is needed for receiving the response signals and for providing the test result at an output of the test unit. These contributions define the entire test time. It should be noted that the term “comprising” does not exclude other elements or features and the “a” or “an” does not exclude a plurality. Also elements described in association with different embodiments may be combined. It should also be noted that reference signs in the claims shall not be construed as limiting the scope of the claims.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1-19. (canceled)

20: An apparatus for estimating a duration of a test of a device under test to be performed by a test device, the apparatus comprising:
an input unit adapted for receiving test information indicative of the test to be performed and for receiving a model characterizing the test; and
a processing unit adapted to estimate the duration of the test of the device under test performed by the test device based on the received test information and based on the model characterizing the test.

21: The apparatus of claim 20, wherein the test information comprises at least one of the group consisting of: information indicative of the device under test, information indicative of the test device, and information indicative of a test routine to be applied to the device under test by the test device during the test.

22: The apparatus of claim 20, further comprising a database in which the model characterizing the test is pre-stored.

23: The apparatus of claim 20, wherein the model characterizing the test is at least one of the group consisting of: a theoretical model of the test, a mathematical model of the test, a model parameterizing the test, and a model structuring the test.

24: The apparatus of claim 20, wherein the model characterizing the test comprises at least one of the group consisting: of a formula for calculating the duration of the test based on received test information, empiric data derived from previously performed tests, and experimental data measured during previously performed tests.

25: The apparatus of claim 20, wherein the model characterizing the test takes into account at least one of the group consisting of: a warm-up time of the test device before starting the test, a test result transmission time of the test device after finishing the test, a clock rate with which the test is performable, a number of test interfaces of the device under test, a number of sub-regions of the device under test, a number of connection pins of the device under test, a number of devices under test, a switch time for switching between different test steps during performing the test, and a delay time resulting from an at least partially sequential test.

26: The apparatus of claim 20, wherein the device under test comprises at least one of the group consisting of: a memory device, a DRAM memory device, a logic circuit, an electric circuit, an integrated circuit, a processor, a system-on-chip, and a hybrid circuit.

27: The apparatus of claim 20, wherein the processing unit is adapted to evaluate a cost for performing the test based on the estimated duration of the test and based on predetermined cost per time data.

28: The apparatus of claim 20, adapted for estimating a duration of a test of a plurality of devices under test (204) to be performed by the test device.

29: The apparatus of claim 20, further comprising an output unit adapted to output the estimated duration of the test.

30: The apparatus of claim 20, further comprising a proposal unit adapted to propose a modification of the test so as to decrease or minimize the duration of the test.

31: The apparatus of claim 30, wherein the proposal unit is adapted to propose the modification based on expert rules or based on result of a computer fit.

32: The apparatus of claim 20, further comprising a test unit for physically performing the test of the device under test.

33: A method of estimating a duration of a test of a device under test performed by a test device, the method comprising:
receiving test information indicative of the test to be performed and a model characterizing the test; and
estimating the duration of the test of the device under test performed by the test device based on the received test information and based on the model characterizing the test.

34: The method of claim 33, further comprising receiving the test information via a communication network, particularly via the Internet.

35: The method of claim 33, further comprising transmitting the estimated duration of the test via a communication network, particularly via the Internet.

36: A computer-readable medium, in which a computer program for estimating a duration of a test of a device under test to be performed by a test device is stored, in which the computer program, when being executed by a processor, is adapted to control or carry out a method of:
receiving test information indicative of the test to be performed and a model characterizing the test; and
estimating the duration of the test of the device under test performed by the test device based on the received test information and based on the model characterizing the test.
